(19) United States
(12) Patent Application Publication
(10) Pub. No.: US 2006/0177334 A1
(43) Pub. Date: Aug. 10, 2006

(54) Axial force reducing structure of orbiting vane compressor

(75) Inventors: Seon-woong Hwang, Anyang-Si (KR); Dong-won Yoo, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/208,530

(22) Filed: Aug. 23, 2005

(30) Foreign Application Priority Data
Feb. 4, 2005 (KR) 10-2005-0010705

(51) Int. Cl. F04C 18/00; F03C 2/00

(52) U.S. Cl. 418/55.5

(57) ABSTRACT

Disclosed herein is an axial force reducing structure of an orbiting vane compressor that is capable of reducing an axial force, i.e. upright force to be applied downward from the upper surface of a vane plate provided in an orbiting vane of the compressor. The axial force reducing structure includes a protrusion formed along the outer periphery of an annular space defined in a compressor cylinder, and a recessed portion around the protrusion, thereby serving to reduce an axial force of high-pressure refrigerant gas to push the vane plate to the cylinder.

### BACKGROUND OF THE INVENTION

1. Field of the Invention

The present invention relates to orbiting vane compressors, and more particularly, to an axial force reducing structure of an orbiting vane compressor that is capable of reducing an axial force, namely, upright force, applied downward from the upper surface of a vane plate included in an orbiting vane.

2. Description of the Related Art

FIG. 1 illustrates the interior configuration of a general orbiting vane compressor. Referring to FIG. 1, the orbiting vane compressor generally comprises a shell 1 configured such that refrigerant gas is introduced through a lower refrigerant suction tube 1a and is discharged to the outside of the shell 1 through an upper refrigerant discharge tube 1b. A crankshaft 6 is vertically mounted in the shell 1 to be rotatably supported by means of upper and lower flanges 7 and 7a. The crankshaft 6 has an eccentric unit 6a at the lower portion thereof. A drive unit D and a compression unit P are also mounted in the shell 1 at the upper and lower portions of the crankshaft 6. The drive unit D includes a stator 2, and a rotor 3 disposed in the stator 2 to drive the crankshaft 6 upon receiving electric current. The compression unit P includes an orbiting vane 4 coupled to the eccentric unit 6a of the crankshaft 6, and a cylinder 5 disposed beneath the orbiting vane 4. The orbiting vane 4 has a circular vane 41, which performs an orbiting movement in an annular space 51, defined between an inner ring 52 and the inner wall of the cylinder 5, according to a rotation of the crankshaft 6. As a result of the orbiting movement, refrigerant gas, introduced into the cylinder 5 through an inlet 53 formed at one side of the cylinder 5, is compressed and discharged to the interior of the shell 1.

After being compressed in the annular space 51 of the cylinder 5 through the orbiting movement of the orbiting vane 4, the refrigerant gas is discharged to a muffler 8, which encloses a lower surface of the lower flange 7a, by passing through the cylinder 5 and the lower flange 7a, thereby being discharged to the interior of the shell 1 via a discharge pipe 9 provided at the muffler 8.

FIG. 2 is an exploded perspective view illustrating the compression unit P of the general orbiting vane compressor. Referring to FIG. 2, as stated above, the compression unit P of the conventional orbiting vane compressor includes the cylinder 5 disposed in the lower region of the compressor and having the annular space 51 defined between the inner ring 52 and the inner wall of the cylinder 5, and the orbiting vane 4 having the circular vane 41 and a boss 42 formed at the lower surface of a vane plate 43 to be inserted respectively into the annular space 51 and the inner ring 52, the orbiting vane 4 performing an orbiting movement. The compression unit P further includes a slider 54 inserted into the annular space 51 to perform a reciprocating movement while coming into close contact at a lateral surface thereof with a linear lateral edge of the circular vane 41 defining an opening 41a.

The annular space 51 includes a linear portion 51a in one end region thereof. The slider 54 is inserted in the linear portion 51a such that the lateral surface thereof comes into close contact with the linear lateral edge of the circular vane 41 defining the opening 41a. As the circular vane 41 performs an orbiting movement, the slider 54 linearly reciprocates in the linear portion 51a.

The slider 54 configured as stated above serves to isolate a pair of compression chambers, defined at the inside and the outside of the circular vane 41, from each other as it is disposed in the opening 41a of the circular vane 41. The slider 54 performs a reciprocating movement while coming into close contact with the linear lateral edge of the circular vane 41 defining the opening 41a, the inner wall of the cylinder 5 at the linear portion 51a of the annular space 51, and the lower surface of the vane plate 43.

However, the above described prior art has a problem that high-pressure refrigerant gas is distributed on the upper surface of the vane plate to thereby apply an excessive axial force, i.e. upright force, downward from the upper surface of the vane plate.

The excessive axial force causes excessive friction between the lower surface of the vane plate and the upper surface of the cylinder. The friction prevents an orbiting movement of the orbiting vane including the vane plate, deteriorating the performance of the compressor.

### SUMMARY OF THE INVENTION

Therefore, the present invention has been made in view of the above problems, and it is an object of the present invention to provide an axial force reducing structure of an orbiting vane compressor which can reduce an axial force, i.e. upright force, applied downward from the upper surface of a vane plate included in an orbiting vane.

It is another object of the present invention to provide an axial force reducing structure of an orbiting vane compressor which can achieve weight balance as well as weight reduction of an orbiting vane.

In accordance with one aspect of the present invention, the above and other objects can be accomplished by the provision of an axial force reducing structure of an orbiting vane compressor, the compressor comprising: a cylinder having an annular space defined between an inner ring and an inner wall of the cylinder; an orbiting vane having a circular vane formed at a vane plate to be inserted into the annular space of the cylinder to perform an orbiting movement; and a slider provided at one end of the circular vane to slide along the annular space, wherein the axial force reducing structure includes a protrusion formed along an outer periphery of the annular space defined in the cylinder to come into contact with the vane plate of the orbiting vane, and a recessed portion formed at the cylinder around the protrusion to be spaced apart from the vane plate, thereby reducing an axial force of high-pressure refrigerant gas to push the vane plate to the cylinder.

In accordance with another aspect of the present invention, the above and other objects can be accomplished by the provision of an axial force reducing structure of an orbiting vane compressor, the compressor comprising: a cylinder having an annular space defined between an inner ring and an inner wall of the cylinder; an orbiting vane having a circular vane formed at a vane plate to be inserted into the annular space of the cylinder to perform an orbiting movement; and a slider provided at one end of the circular vane to slide along the annular space, wherein the axial force reducing structure includes at least one cutout formed at a circumference of the vane plate of the orbiting vane to reduce a contact area between the vane plate and an upper surface of the cylinder, thereby reducing an axial force of high-pressure refrigerant gas to push the vane plate to the cylinder.

Preferably, the at least one cutout may be symmetrically arranged with respect to the opening of the circular vane at an opposite side of the opening.

In accordance with yet another aspect of the present invention, the above and other objects can be accomplished by the provision of an axial force reducing structure of an orbiting vane compressor, the compressor comprising: a cylinder having an annular space defined between an inner ring and the inner wall of the cylinder; an orbiting vane having a circular vane formed at a vane plate to be inserted into the annular space of the cylinder to perform an orbiting movement; and a slider provided at one end of the circular vane to slide along the annular space, wherein the axial force reducing structure includes at least one groove formed at an edge of a lower surface of the vane plate included in the orbiting vane to reduce a contact area between the vane plate and an upper surface of the cylinder, thereby reducing an axial force of high-pressure refrigerant gas to push the vane plate to the cylinder.

Preferably, the at least one groove may be symmetrically arranged with respect to the opening of the circular vane at an opposite side of the opening.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a longitudinal sectional view of a conventional orbiting vane compressor;

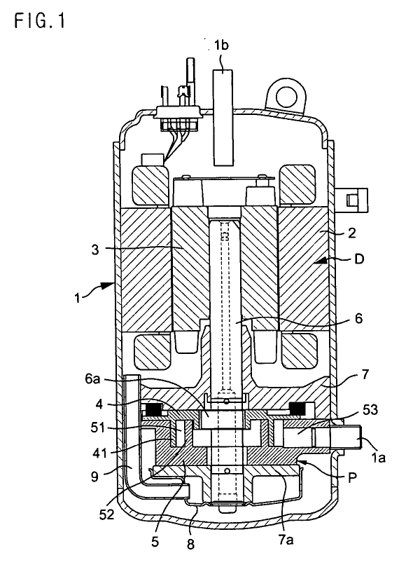

FIG. 2 is an exploded perspective view illustrating a compression unit of the conventional orbiting vane compressor;

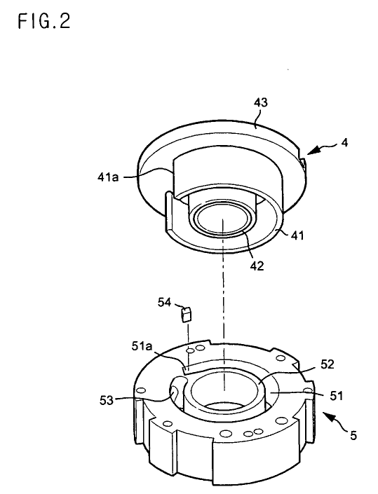

FIG. 3 is an exploded perspective view illustrating a compression unit of an orbiting vane compressor according to a first embodiment of the present invention;

FIG. 4 is an enlarged longitudinal sectional view of the compression unit of FIG. 3, in an assembled state;

FIG. 5 is an exploded perspective view illustrating a compression unit of an orbiting vane compressor according to a second embodiment of the present invention;

FIG. 6 is an enlarged longitudinal sectional view of the compression unit of FIG. 5, in an assembled state;

FIG. 7 is an exploded perspective view illustrating a compression unit of an orbiting vane compressor according to a third embodiment of the present invention; and

FIG. 8 is an enlarged longitudinal sectional view of the compression unit of FIG. 7, in an assembled state.

### DESCRIPTION OF THE PREFERRED EMBODIMENTS

Now, preferred embodiments of the present invention will be explained with reference to the accompanying drawings.

In the drawings, the same or similar elements are denoted by the same reference numerals even though they are depicted in different drawings in relation with different preferred embodiments.

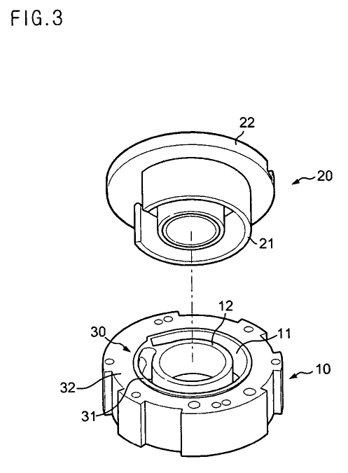

FIG. 3 is an exploded perspective view illustrating a compression unit of an orbiting vane compressor according to a first embodiment of the present invention.

Referring to FIG. 3, the compression unit of the orbiting vane compressor according to the first embodiment of the present invention comprises a cylinder 10 mounted in the lower region of the compressor and having an annular space 11 defined between an inner ring 12 and the inner wall of the cylinder 10, an orbiting vane 20 having a circular vane 21 integrally formed at the lower surface of a vane plate 22 to be inserted into the annular space 11 of the cylinder 10, a slider (not shown) located at one end of the circular vane 21 to slide along the annular space 11, and an axial force reducing structure 30 formed at the upper surface of the cylinder 10.

The annular space 11 of the cylinder 10 is closed at a part thereof to have both end regions. One of the end regions of the annular space 11 forms a linear portion extending in a tangential direction of the annular space 11. The slider (not shown) is inserted into the linear portion to perform a reciprocating movement along the linear portion.

The orbiting vane 20 has a boss inside the circular vane 21 to be inserted into the inner ring 12 of the cylinder 10. A crankshaft (not shown) of the compressor is coupled into the boss.

In the first embodiment of the present invention, the axial force reducing structure 30 includes a protrusion 31 formed at the upper surface of the cylinder 10 along the outer periphery of the annular space 11 to come into contact with the lower surface of the vane plate 22, and a recessed portion 32 formed at the remaining part of the upper surface of the cylinder 10 around the protrusion 31 to be spaced apart from the lower surface of the vane plate 22.

That is, the recessed portion 32 is spaced apart from the lower surface of the vane plate 22 when the protrusion 31 comes into contact with the lower surface of the vane plate 22. This has the effect of reducing the axial force, i.e. upright force, to be applied downward from the upper surface of the vane plate 22 due to the high-pressure refrigerant gas.

In other words, by allowing the lower surface of the vane plate 22 to come into contact with the upper surface of the cylinder 10 only partially, the axial force, i.e. upright force, of the vane plate 22 to be applied to the upper surface of the cylinder 10 can be reduced.

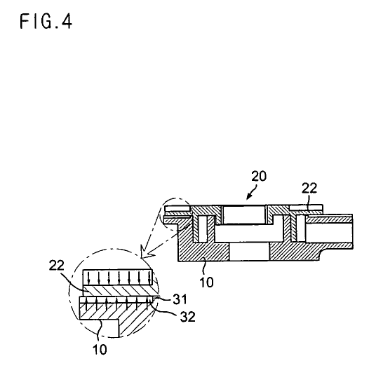

Such an axial force reduction facilitates an orbiting movement of the orbiting vane 20 including the vane plate 22, resulting in improved compressor performance. FIG. 4 is an enlarged longitudinal sectional view of the compression unit of FIG. 3, in an assembled state.

Arrows shown in a dashed circle of FIG. 4 indicate directions of forces applied to the vane plate 22.

Referring to FIG. 4, when high-pressure refrigerant gas applies an axial force, i.e. upright force, to the upper surface of the vane plate 22, in a state wherein the vane plate 22 is supported by the protrusion 31 of the cylinder 10 that comes into contact with the lower surface of the vane plate 22, the high-pressure refrigerant gas can be introduced into the recessed portion 32 to thereby apply an upward repulsive force to the vane plate 22.

The upward repulsive force produced in the recessed portion 32 acts to partially offset and reduce the axial force to be applied downward from the vane plate 22. This has the effect of reducing friction generated between the vane plate 22 and the protrusion 31 of the cylinder 10 that comes into contact with the vane plate 22.

The friction reduction provides a more stable orbiting movement of the orbiting vane 20 including the vane plate 22, resulting in improved compressor performance.

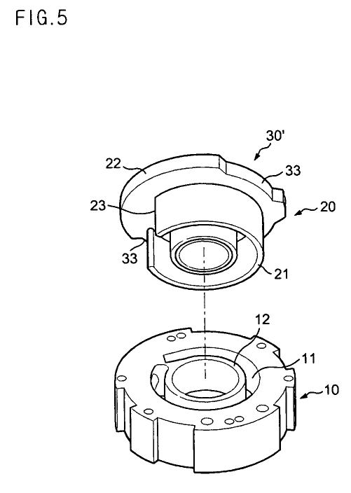

FIG. 5 is an exploded perspective view illustrating a compression unit of an orbiting vane compressor according to a second embodiment of the present invention.

Referring to FIG. 5, the compression unit of the orbiting vane compressor according to the second embodiment of the present invention comprises the cylinder 10 mounted in the lower region of the compressor and having the annular space 11 defined between the inner ring 12 and the inner wall of the cylinder 10, the orbiting vane 20 having the circular vane 21 integrally formed at the lower surface of the vane plate 22 to be inserted into the annular space 11 of the cylinder 10, a slider (not shown) located at one end of the circular vane 21 to slide along the annular space 11, and an axial force reducing structure 30′ formed at the circumference of the vane plate 22.

The annular space 11 of the cylinder 10 is closed at a part thereof to have both end regions. One of the end regions of the annular space 11 forms a linear portion extending in a tangential direction of the annular space 11. The slider (not shown) is inserted into the linear portion to perform a reciprocating movement along the linear portion.

The orbiting vane 20 has a boss inside the circular vane 21 to be inserted into the annular space 11 of the cylinder 10. A crankshaft (not shown) of the compressor is coupled into the boss.

The axial force reducing structure 30′ according to the second embodiment of the present invention includes one or more cutouts 33 formed at the circumference of the vane plate 22 to reduce the contact area between the vane plate 22 and the upper surface of the cylinder 10.

In addition to reducing the contact area between the vane plate 22 and the cylinder 10 by virtue of the cutouts 33, the axial force reducing structure 30′ of the present embodiment reduces the weight of the orbiting vane 20 including the vane plate 22, thereby serving to reduce an axial force, i.e. upright force to be applied downward from the upper surface of the vane plate 22 due to the high-pressure refrigerant gas.

In other words, by cutting out part of the vane plate 22 to reduce the contact area between the vane plate 22 and the upper surface of the cylinder 10 as well as the weight of the vane plate 22, the axial force, i.e. upright force, of the vane plate 22 to be applied to the upper surface of the cylinder 10 can be reduced.

The axial force reduction enables a more smooth orbiting movement of the orbiting vane 22 including the vane plate 22, resulting in improved compressor performance. In the present embodiment, the cutouts 33 are arranged with respect to an opening 23 formed at the circular vane 21 of the orbiting vane 20 in consideration of the weight balance of the orbiting vane 20. For example, one cutout 33 may be arranged opposite to the opening 23, or two or more cutouts 33 may be symmetrically arranged about the opening 23 at an opposite side of the opening 23.

In this way, the orbiting vane 20 can achieve appropriate weight balance to reduce the axial force and the weight thereof while performing a stable orbiting movement in spite of the fact that it is partially cut out to form the cutouts 33.

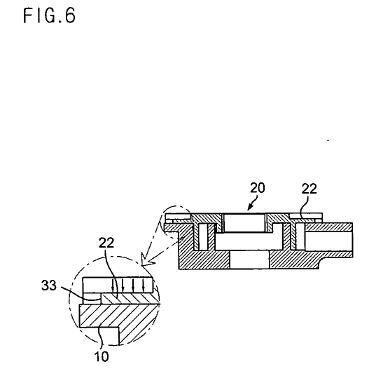

FIG. 6 is an enlarged longitudinal sectional view of the compression unit of FIG. 5, in an assembled state.

Arrows shown in a dashed circle of FIG. 6 indicate the direction of forces applied to the vane plate 22.

Referring to FIG. 6, when high-pressure refrigerant gas applies an axial force, i.e. upright force, to the upper surface of the vane plate 22, the cutouts 33 of the vane plate 22 act to reduce the axial force, i.e. upright force applied by the vane plate 22.

As a result of reducing the axial force, i.e. upright force applied by the vane plate 22 by virtue of the cutouts 33, friction generated between the lower surface of the vane plate 22 and the upper surface of the cylinder 10 that comes into contact with the lower surface of the vane plate 22 can be reduced.

The friction reduction provides a more stable orbiting movement of the orbiting vane 20 including the vane plate 22, resulting in improved compressor performance.

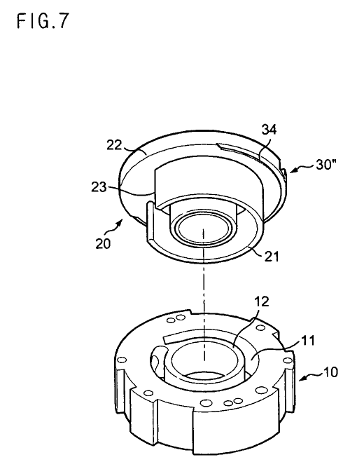

FIG. 7 is an exploded perspective view illustrating a compression unit of an orbiting vane compressor according to a third embodiment of the present invention.

Referring to FIG. 7, the compression unit of the orbiting vane compressor according to the third embodiment of the present invention comprises the cylinder 10 mounted in the lower region of the compressor and having the annular space 11 defined between the inner ring 12 and the inner wall of the cylinder 10, the orbiting vane 20 having the circular vane 21 integrally formed at the lower surface of the vane plate 22 to be inserted into the annular space 11 of the cylinder 10, a slider (not shown) located at one end of the circular vane 21 to slide along the annular space 11, and an axial force reducing structure 30″ formed at the periphery of the lower surface of the vane plate 22.

The annular space 11 of the cylinder 10 is closed at a part thereof to have both end regions. One of the end regions of the annular space 11 forms a linear portion extending in a tangential direction of the annular space 11. The slider (not shown) is inserted into the linear portion to perform a reciprocating movement along the linear portion.

The orbiting vane 20 has a boss inside the circular vane 21 to be inserted into the annular space 11 of the cylinder 10. A crankshaft (not shown) of the compressor is coupled through the boss.

The axial force reducing structure 30″ according to the third embodiment of the present embodiment includes one or more grooves 34 formed at the edge of the lower surface of the vane plate 22 to reduce the contact area between the lower surface of the vane plate 22 and the upper surface of the cylinder 10.

In addition to reducing the contact area between the vane plate 22 and the cylinder 10 by virtue of the grooves 34, the axial force reducing structure 30″ of the present embodiment allows high-pressure refrigerant gas to be introduced into the grooves 34 to thereby apply an upward repulsive force to the lower surface of the vane plate 22. The upward repulsive force produced in the grooves 34 acts to reduce the axial force to be applied downward from the upper surface of the vane plate 22 due to the high-pressure refrigerant gas.

In other words, forming the grooves 34 at the lower surface of the vane plate 22 can reduce the contact area between the lower surface of the vane plate 22 and the upper surface of the cylinder 10 and can allow the high-pressure refrigerant to be introduced into the grooves 34 to thereby apply the repulsive force, thereby achieving a reduction of the axial force, i.e. upright force of the vane plate 22 applied to the upper surface of the cylinder 10.

The axial force reduction enables a more smooth orbiting movement of the orbiting vane 20 including the vane plate 22, resulting in improved compressor performance. In the present embodiment, the grooves 34 are arranged with respect to the opening 23 formed at the circular vane 21 of the orbiting vane 20 in consideration of the weight balance of the orbiting vane 20. For example, one groove 34 may be arranged opposite to the opening 23, or two or more grooves 34 may be symmetrically arranged about the opening 23 at an opposite side of the opening 23.

In this way, the orbiting vane 20 can achieve appropriate weight balance to reduce the axial force and the weight thereof while performing a stable orbiting movement in spite of the fact that it is partially recessed to form the grooves 34.

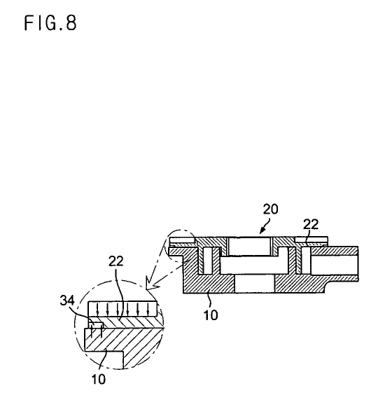

FIG. 8 is an enlarged longitudinal sectional view of the compression unit of FIG. 7, in an assembled state.

Arrows shown in a dashed circle of FIG. 8 indicate the directions of forces applied to the vane plate 22.

Referring to FIG. 8, when high-pressure refrigerant gas applies an axial force, i.e. upright force, to the upper surface of the vane plate 22, by virtue of the grooves 34 formed at the lower surface of the vane plate 22, the lower surface of the vane plate 22 can come into contact with the upper surface of the cylinder 10 with a reduced contact area, and the high-pressure refrigerant gas can be introduced into the grooves 34 to thereby apply an upward repulsive force to the vane plate 22.

The upward repulsive force produced in the grooves 34 acts to partially offset and reduce the axial force to be applied downward from the vane plate 22, thereby achieving a reduction of friction generated between the vane plate 22 and the upper surface of the cylinder 10 that comes into contact with the vane plate 22. The friction reduction enables a more stable orbiting movement of the orbiting vane 20 including the vane plate 22, resulting in improved compressor performance.

As apparent from the above description, the present invention provides an axial force reducing structure of an orbiting vane compressor which can reduce an axial force, i.e. upright force, applied downward from the upper surface of a vane plate included in an orbiting vane, thereby preventing generation of excessive friction between the lower surface of the vane plate and the upper surface of a cylinder that comes into contact with the lower surface of the vane plate, resulting in smooth orbiting movement of the orbiting vane and improved compressor performance.

Further, the present invention achieves the weight balance as well as weight reduction of the orbiting vane, enabling a more stable orbiting movement of the orbiting vane.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An axial force reducing structure of an orbiting vane compressor, the compressor comprising: a cylinder having an annular space defined between an inner ring and an inner wall of the cylinder; an orbiting vane having a circular vane formed at a vane plate to be inserted into the annular space of the cylinder to perform an orbiting movement; and a slider provided at one end of the circular vane to slide along the annular space,
wherein the axial force reducing structure includes a protrusion formed along an outer periphery of the annular space defined in the cylinder to come into contact with the vane plate of the orbiting vane.

2. The structure as set forth in claim 1, wherein the axial force reducing structure further includes a recessed portion formed at the cylinder around the protrusion to be spaced apart from the vane plate.

3. The structure as set forth in claim 1, wherein the annular space is closed at a part thereof to have both end regions.

4. The structure as set forth in claim 3, wherein: the annular space of the cylinder has a linear portion extending in a tangential direction of the annular space in one of the end regions; and
the slider is inserted into the linear portion to perform a linear reciprocating movement along the linear portion.

5. The structure as set forth in claim 4, wherein the circular vane of the orbiting vane, inserted into the annular space of the cylinder, has both ends defining an opening therebetween.

6. The structure as set forth in claim 1, wherein: the orbiting vane further has a boss inside the circular vane to be coupled with a crankshaft of the compressor; and
the boss is inserted into the inner ring of the cylinder.

7. An axial force reducing structure of an orbiting vane compressor, the compressor comprising: a cylinder having an annular space defined between an inner ring and an inner wall of the cylinder; an orbiting vane having a circular vane formed at a vane plate to be inserted into the annular space of the cylinder to perform an orbiting movement; and a slider provided at one end of the circular vane to slide along the annular space,
wherein the axial force reducing structure includes at least one cutout formed at a circumference of the vane plate of the orbiting vane that comes into contact with the cylinder.

8. The structure as set forth in claim 7, wherein the annular space is closed at a part thereof to have both end regions.

9. The structure as set forth in claim 8, wherein: the annular space of the cylinder has a linear portion extending in a tangential direction of the annular space in one of the end regions; and
the slider is inserted into the linear portion to perform a linear reciprocating movement along the linear portion.

10. The structure as set forth in claim 9, wherein the circular vane of the orbiting vane, inserted into the annular space of the cylinder, has both ends defining an opening therebetween.

11. The structure as set forth in claim 10, wherein the at least one cutout is symmetrically arranged with respect to the opening of the circular vane at an opposite side of the opening.

12. The structure as set forth in claim 7, wherein: the orbiting vane further has a boss inside the circular vane to be coupled with a crankshaft of the compressor; and
the boss is inserted into the inner ring of the cylinder.

13. An axial force reducing structure of an orbiting vane compressor, the compressor comprising: a cylinder having an annular space defined between an inner ring and the inner wall of the cylinder; an orbiting vane having a circular vane formed at a vane plate to be inserted into the annular space of the cylinder to perform an orbiting movement; and a slider provided at one end of the circular vane to slide along the annular space,
wherein the axial force reducing structure includes one or more grooves formed at an edge of a lower surface of the vane plate included in the orbiting vane that comes into contact with an upper surface of the cylinder.

14. The structure as set forth in claim 13, wherein the annular space is closed at a part thereof to have both end regions.

15. The structure as set forth in claim 14, wherein:
the annular space of the cylinder has a linear portion extending in a tangential direction of the annular space in one of the end regions; and
the slider is inserted into the linear portion to perform a linear reciprocating movement along the linear portion.

16. The structure as set forth in claim 15, wherein the circular vane of the orbiting vane, inserted into the annular space of the cylinder, has both ends defining an opening therebetween.

17. The structure as set forth in claim 16, wherein the at least one groove is symmetrically arranged with respect to the opening of the circular vane at an opposite side of the opening.

18. The structure as set forth in claim 13, wherein:
the orbiting vane further has a boss inside the circular vane to be coupled with a crankshaft of the compressor; and
the boss is inserted into the inner ring of the cylinder.
